(19) United States
(12) Patent Application Publication
(10) Pub. No.: US 2013/0157015 A1
(43) Pub. Date: Jun. 20, 2013

(54) Precisely Locating Components in an Infrared Welded Assembly

(71) Applicant: Steven E. Morris, Fair Haven, MI (US)

(72) Inventor: Steven E. Morris, Fair Haven, MI (US)

(73) Assignee: GM GLOBAL TECHNOLOGY OPERATIONS LLC, DETROIT, MI (US)

(21) Appl. No.: 13/330,718

(22) Filed: Dec. 20, 2011

(51) Int. Cl. B32B 3/30; B23P 17/00; B32B 37/06

(52) U.S. Cl. 428/167; 156/272.2; 29/466

(57) ABSTRACT

Elastic averaging infrared welded assembly. A first component has left and right longitudinal sidewalls. A second component has a plurality of localized locating features at each of the left and right longitudinal sides thereof which abut the left and right sidewalls of the first component so as to cause the left and right sidewalls to flex outwardly so as to precisely self-align by elastic averaging the first and second components. The mutually abutting ribs are conjoined, preferably by infrared welding.

### TECHNICAL FIELD

The present invention relates to precise location of components to be infrared welded together, and more particularly to a plurality of locating features with provide self alignment of the components via elastic averaging.

### BACKGROUND OF THE INVENTION

Currently in the prior art, all infrared welded components are assembled using fixtures that locate the two mating components to each other. This produces assemblies in which the components have positional variation with respect to each other due to fixture variance, fixture-to-component clearance which is needed in order to provide reliable loading of each component into its respective fixture, and component variance. Accordingly in the prior art, the periphery of one component is allowed to “float” relative to the periphery of the other mating component during assembly. As such, any variance of the components will be frozen when the infrared welding transpires. The resulting welded assembly variance may not only provide an unsightly result, but an assembly that may not be a strong as it could otherwise be and may have difficulty being mated to other components.

By way of example, FIGS. 1 through 3 illustrate prior art components assembly during an infrared welding process.

Referring firstly to FIG. 2, a first component 10 has a left sidewall 12, a right sidewall 14, formed of an inverted U-shape 15, and a plurality of first ribs 16 formed on a first base wall 18 which has a Class B (intended to be unseen) surface, and running longitudinally in generally equally spaced relation between the left and right sidewalls. A Class A (intended to be visible) surface 20, being leather or simulated leather vinyl material, but could be otherwise, such as a hard material, is disposed mainly in spaced relation to the first base wall 18, via a foam padding 25, and wraps around the left and right sidewalls. A second component 22 has a plurality of mutually spaced apart left abutments 24 each having a left abutment surface 26, a plurality of mutually spaced apart right abutments 28 each having a right abutment surface 30 and a plurality of second ribs 32 formed on a second base wall 34, which has a Class B (intended to be unseen) surface, and running longitudinally in generally equally spaced relation between the left and right abutments. A Class A (intended to be at least partly visible) surface 36 of the second base wall is disposed between left and right longitudinal edge curves 38, 40 thereof, in opposition to the Class B surface of the second base wall, wherein the left abutments 24 adjoin the left longitudinal edge curve 38 of the second base wall, and the right abutments 28 adjoin the right longitudinal edge curve 40 of the second base wall.

A first fixture 42 has a pair of mutually spaced apart fixture walls 44 which are configured to guidingly receive the left and right sidewalls 12, 14 of the first component 10, wherein the first component is by way of example picked-up and held received by a vacuum system 46. Similarly, a second fixture 50 has a pair of mutually spaced apart fixture walls 52 which are configured to guidingly receive the left and right longitudinal edge curves 38, 40 of the second component 22, wherein the second component is by way of example picked-up and held received by the vacuum system 46.

In operation, an infrared platen 58 of an infrared welding apparatus is introduced into the space between the first and second ribs 16, 32, whereupon it is actuated to heat, by infrared radiation, the first and second ribs. Once the tips of the first and second ribs become molten, the infrared platen is removed. The first and second fixtures 42, 50 are robotically brought together such that the first and second components 10, 22 abut at the first and second ribs 16, 32, whereat molten tips of the first and second ribs conjoin. Upon cooling, the first and second ribs are welded together and the first and second fixtures are removed, whereupon provided is an infrared welded assembly 60, as shown at FIG. 1.

In order for component variation, fixture variation and fixture-to-component clearance, a variation “float” is provided by a gap 62 between the separation distance between the inside diameter 64 of the left and right sidewalls 12, 14 of the first component 10 and the outside diameter 66 of the left and right abutments 24, 28 as measured from the left and right abutment surfaces 26, 30 thereof.

While the gap 62 provides assurance the first and second components will be joinable into a welded assembly, problematically the gap allows for the first and second components to laterally shift relative to each other by as much as the gap. In this regard, while FIG. 1 shows an “ideal” situation in which the welded assembly 60 has a gap 62′ that is proportioned about equally at each of the left and right sides 68, 70, FIG. 3 shows what happens if the gap 62″, for example on the order of about 1.0 mm, is untowardly disposed entirely at one of the right or left sides 68′, 70′, in this case the right side 70′ of the welded assembly; the fit is poor, the ribs do not well align making for weak welds thereat, and the look is not Class A.

Accordingly, what remains needed in the art is to somehow provide an alignment modality for the mating of first and second components with respect to an infrared welding process, wherein when mating is completed there is absence of a gap, the fit being precise.

### SUMMARY OF THE INVENTION

The present invention uses elastic averaging to provide alignment for the mating of the first and second components of an assembly being infrared welded, wherein the elastic averaging assures precise location of the first and second components relative to each other.

A first component has left and right longitudinal sidewalls. A second component has a plurality of localized locating features at each of the left and right longitudinal edges thereof, wherein the plurality of locating features have locating surfaces which abut respective inner surfaces of the left and right longitudinal sidewalls of the first component so as to cause the left and right longitudinal sidewalls to resiliently flex outwardly therefrom. The first component has a plurality of first ribs, and the second component has a plurality of second ribs.

Prior to mating of the first and second components, an infrared platen is placed therebetween and then activated, whereupon the tips of the first and second ribs become molten. The platen is then removed and the first and second components are mated, whereupon the first and second components self-align by elastic averaging and the tips of the first and second ribs conjoin. Upon cooling, an elastic averaging infrared welded assembly is provided. In this regard, the location of the locating features with respect to the inner surfaces of the left and right longitudinal sidewalls is predetermined to provide an elastic averaging which anticipates a predetermined total structural variance, as for example due to structural variances during manufacturing of the first and second components. Further, since the first and second components are fitted together by operation of the locating surfaces abutting the inner surfaces of the first and second sidewalls, there is no need for a fixture to align the components during assembly, whereby any and all fixture associated variation is obviated.

The plurality of locating features have local variations in manufacture which are significantly smaller than that of the predetermined structural variation of the first and second components. In addition, by resiliently preloading the longitudinal periphery of the elastic averaging infrared welded assembly, as a result of resilient abutment of the first and second longitudinal sidewalls with respect to the locating features, an inherent stiffness is imparted to the elastic averaging infrared welded assembly, wherein a localized torsional load from one of the first and second components to the other of the first and second components is transferred to the entire longitudinal periphery of the elastic averaging infrared welded assembly.

Accordingly, it is an object of the present invention to provide an elastic averaged mating between first and second components in an infrared welding process, wherein when mating is completed the elastic averaging assures precise location of the first component relative to the second component.

This and additional objects, features and advantages of the present invention will become clearer from the following specification of a preferred embodiment.

### BRIEF DESCRIPTION OF THE DRAWINGS

FIG. 1 is a perspective, sectional view of a first infrared welded assembly in accordance with the prior art.

FIG. 2 is a schematic, exploded sectional view of an assembly process for first and second components of an assembly to be infrared welded in accordance with the prior art.

FIG. 3 is a sectional end view of a second infrared welded assembly in accordance with the prior art.

FIG. 4 is a perspective, sectional view of an elastic averaging aligned infrared welded assembly in accordance with the present invention.

FIG. 5 is a perspective, sectional view of a bottom view of a first component of the elastic averaging aligned infrared welded assembly of FIG. 4.

FIG. 6 is a perspective, sectional view of a bottom view of a second component of the elastic averaging aligned infrared welded assembly of FIG. 4.

FIG. 7 is a schematic, exploded sectional view of an initial stage of an assembly process according to the present invention in which the first and second components are subjected to infrared radiation to melt the tips of the mutually facing ribs thereof.

FIG. 8 is a schematic, exploded sectional view of a middle stage of the assembly process in accordance with the present invention in which the first and second components are about to undergo elastic averaging alignment after having been heat processed by infrared radiation.

FIG. 9 is a schematic, exploded sectional view of a final stage of an assembly process in accordance with the present invention in which the first and second components have been elastic averaging aligned and the tips of the ribs now conjoined to form the elastic averaging aligned infrared welded assembly of FIG. 4.

FIG. 10 is a detail view, seen at circle 10 of FIG. 9.

FIG. 11 is a detail view, seen at circle 11 of FIG. 9.

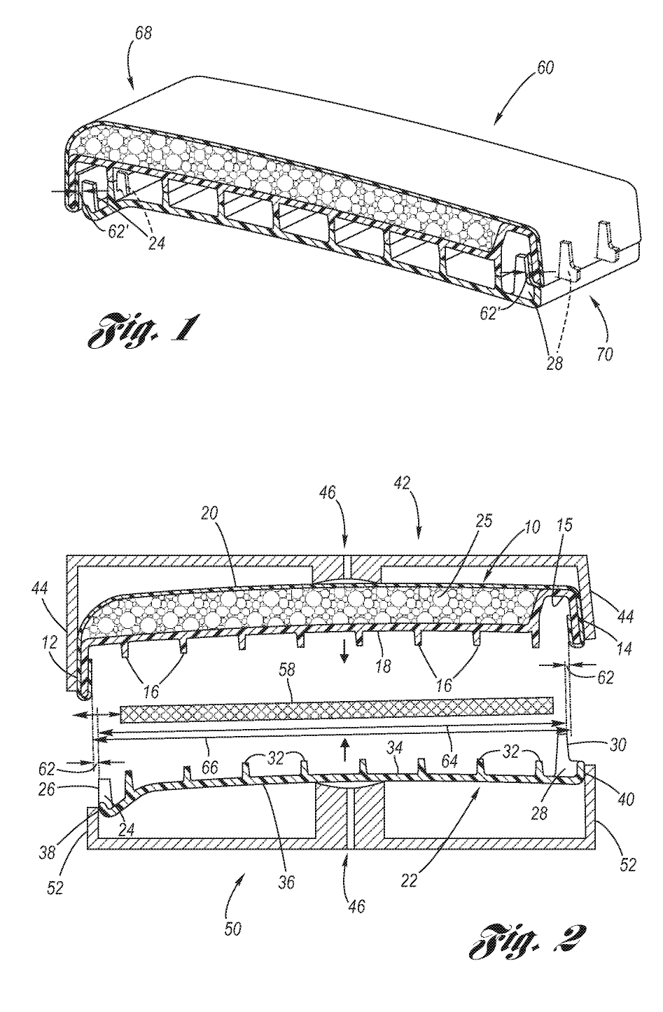

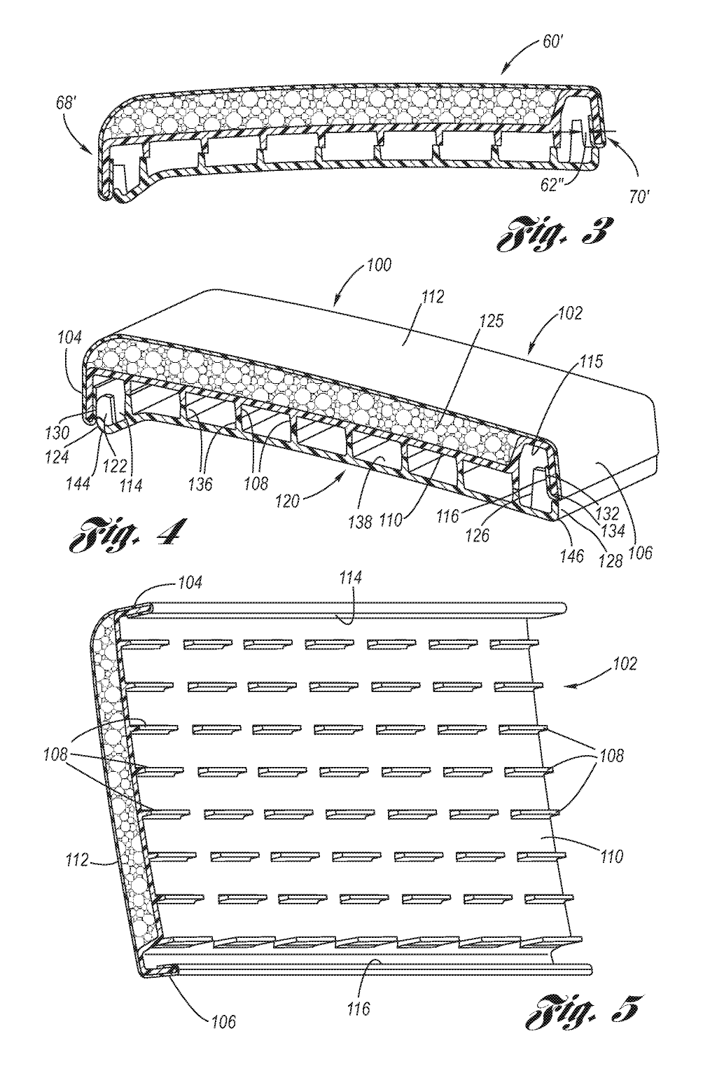

### DESCRIPTION OF THE PREFERRED EMBODIMENT

Referring now to the Drawings, FIGS. 4 through 11 depict various examples of the structure and function of the elastic averaging aligned infrared welded assembly 100 according to the present invention.

As shown at FIGS. 4 and 5, a first component 102 of the elastic averaging infrared welded assembly 100 has a left longitudinal sidewall 104, a right longitudinal sidewall 106, formed of an inverted U-shape 115, and a plurality of first ribs 108 formed on a first base wall 110 which is, by way of example, a Class B (intended to be unseen) surface. The first ribs 108 run longitudinally in generally equally spaced relation between the left and right longitudinal sidewalls. A Class A (intended to be visible) surface 112, being leather or simulated leather vinyl material, but could be otherwise, such as a hard material, is disposed, by way of example, mainly in spaced relation to the first base wall 110, via, by way of example, a foam padding 125 and wraps around the left and right longitudinal sidewalls 104, 106 so as to be conjoined thereto and forming a part thereof. The left longitudinal sidewall has a left inner sidewall surface 114, and the right longitudinal has a right inner sidewall surface 116.

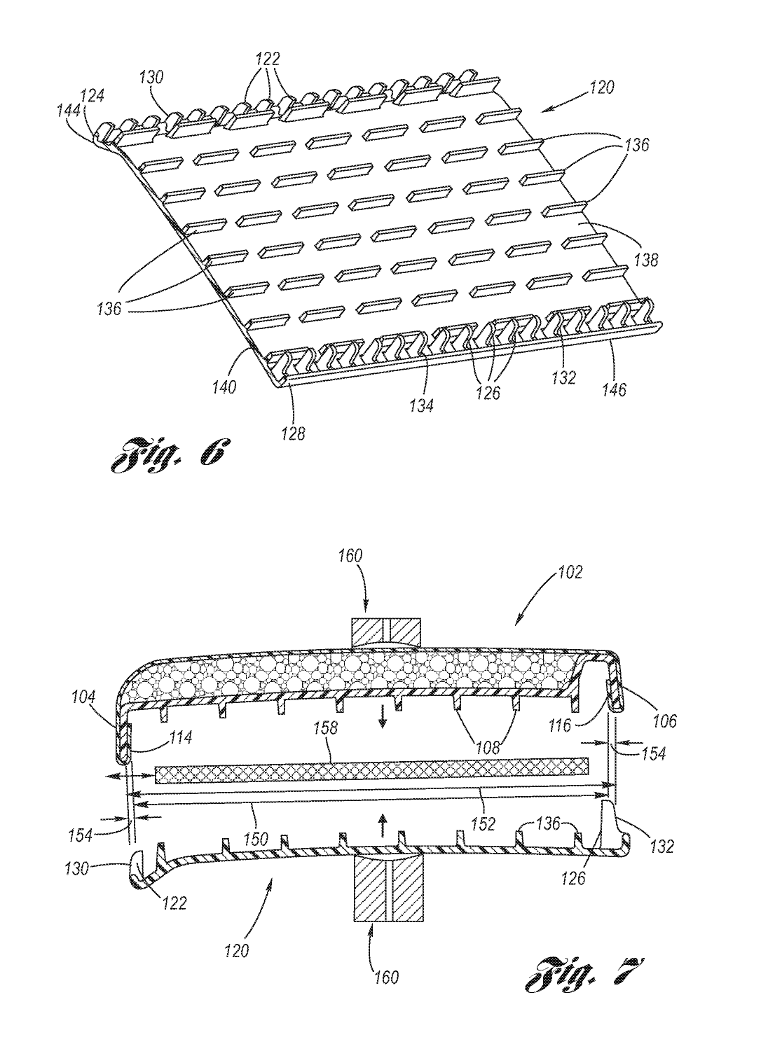

As shown at FIGS. 4 and 6, a second component 120 has a plurality of mutually spaced apart left locating features 122 disposed, with preferably mutually equidistant spacing, along a left longitudinal edge 124 of the second component, and further has a plurality of mutually spaced apart right locating features 126 disposed, with preferably mutually equidistant spacing, along a right longitudinal edge 128 of the second component. Each of the left locating features 122 has a left locating surface 130, and each of the right locating features has a right locating surface 132, which preferably includes a floor surface 134. A plurality of second ribs 136, one second rib for each first rib, is formed on a second base wall 138 which is, by way of example, a Class B (intended to be unseen) surface. The second ribs 136 run longitudinally in generally equally spaced relation between the left and right locating features 122, 126. A preferably Class A (intended to be at least partly visible) surface 140 of the second base wall 138 is disposed between left and right longitudinal edges 124, 128 thereof, in opposition to the Class B surface of the second base wall. The left longitudinal edge 124 may be formed as a left longitudinal edge curve 144, wherein the left locating features 122 adjoin the left longitudinal edge curve. The right longitudinal edge 128 may be formed as a right longitudinal edge curve 146, wherein right locating features 126 adjoin the right longitudinal edge curve.

The location of the left and right locating features 122, 126 with respect to the left and right inner sidewall surfaces 114, 116 is predetermined to provide an elastic averaging which anticipates a predetermined maximum structural variance of the first and second components 102, 120, as for example due to the manufacturing of the first and second components, wherein, for example, structural variance may be determined empirically.

FIG. 7 depicts the first and second components 102, 120 both being shown having a predetermined average structural variance. In order to provide the elastic averaging, the left inner wall surface 114 is spaced from the right inner wall surface 116 an inner wall surfaces spacing 150, and the left locating surface 130 is spaced from the right locating surface 132 a locating surfaces spacing 152. Collectively, the inner wall surfaces spacing 150 and the locating surfaces spacing 152 are such that the difference therebetween provides an overlap 154 of a length which is equal to a little more than the predetermined maximum structural variance, whereby the left and right longitudinal sidewalls flex outwardly during mating of the first and second components.

By way of example, a maximum structural variance may be 1.0 mm as between the left and right inner sidewall surfaces 114, 116 of the first component 102 and the left and right locating surfaces 130, 132 of the second component 120. In this example, an overlap 154 of the left and right locating surfaces with respect to the left and right inner sidewall surfaces is required for elastic averaging to effect self-alignment during mating of the first and second components. Thus, in this example, in order to provide assurance of elastic averaging without an undue amount of flexing of the left and right sidewalls, an overlap enhancement would be added to the overlap by an amount greater than 0.0 mm but less than about 0.1 mm (e.g., the overlap has a collective length greater than 1.0 mm, but less than about 1.1 mm).

Mathematically, the precise alignment during mating of the first and second components by elastic averaging can be generalized for the mating of any first and second components by the following relation:

ΔX=ΔX′/√n+ΔX″/√n, (1)

applicable to each of the left and right longitudinal edges where, ΔX is the local structural variance of the length 170, 170′ (see FIGS. 10 and 11) of local positional variation as between the first and second components when mated (e.g., the visible local fit of the first and second components), ΔX′ is the local structural variance of the length 172, 172′ of local position as between the left or right inner sidewall surface 114, 116 of the first component, respectively, and the left or right longitudinal edge 124, 128 of the lower component, respectively, n is the number of left or right locating features, respectively, and ΔX″ is the local structural variance of the length 174, 174′ of total thickness (including the surface 112, if present) of the left or right longitudinal sidewall 104, 106 of the upper component.

The operation of elastic averaging to provide alignment and structural stiffness to the first and second components is depicted at FIGS. 7 through 10.

FIG. 7 depicts an initial stage of an assembly process in which the first and second components 102, 120 are each grasped by a robotic device, as for example by suction grippers 160, wherein there is no need of a fixture to hold the first and second components in that the first and second components will inherently self-align by elastic averaging as they are mated to each other. An infrared platen 158 of an infrared welding apparatus is introduced into the space between the first and second ribs 108, 136, whereupon it is actuated to heat, by infrared radiation, the first and second ribs. Once the tips of the first and second ribs become molten, the infrared platen is removed.

FIG. 8 depicts a middle stage of the assembly process in which the first and second components 102, 120, still grasped by the suction grippers 160 in a manner that permits lateral movement, are now commencing to undergo elastic averaging self-alignment, wherein as further mating transpires the left longitudinal sidewall 104 resiliently flexes leftwardly as the left inner wall surface 114 slidingly abuts the left locating surface 130 of the left locating feature 122, and the right longitudinal sidewall 106 resiliently flexes rightwardly as the right inner wall surface 116 slidingly abuts the right locating surface 132 of the left locating feature 126.

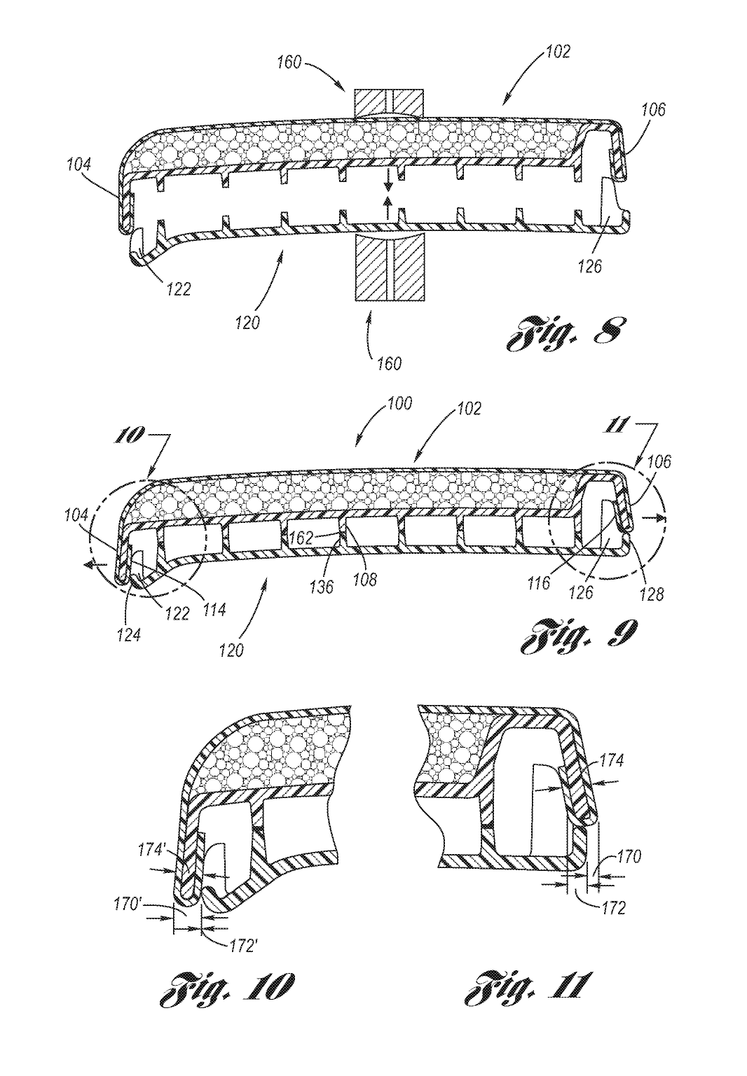

FIG. 9 depicts a final stage of the assembly process in which the first and second components 102, 120 are now fully mated wherein the elastic averaging self-alignment has concluded with the first and second ribs 108, 136 in mutual abutment and the molten tips thereof conjoined 162. As additionally shown in detail at FIG. 10, the elastic averaging self-alignment has the left longitudinal sidewall 104 resiliently flexed leftwardly in preload of the left inner wall surface 114 against the left locating surface 130 of the left locating feature 122, and has the right longitudinal sidewall 106 resiliently flexed rightwardly in preload of the right inner wall surface 116 against the right locating surface 132 of the left locating feature 126. Upon cooling, the first and second ribs 108, 136 are welded together, whereupon the suction grippers 160 are removed and the elastic averaging infrared welded assembly 100 depicted at FIG. 4 is provided.

The plurality of left and right locating features 122, 126 have local variations in manufacture which are significantly smaller than that of the predetermined structural variance of the first and second components 102, 120. In addition, by resiliently preloading the longitudinal periphery of the elastic averaging welded assembly 100, an inherent stiffness is imparted to the elastic averaging welded assembly, wherein a localized torsional load from the first component 102 to the second component 120, and vice versa, is transferred to the entire longitudinal periphery of the elastic averaging welded assembly.

To those skilled in the art to which this invention appertains, the above described preferred embodiment may be subject to change or modification. For example, the first and second components can be mutually conjoined by other than infrared welding. Such change or modification can be carried out without departing from the scope of the invention, which is intended to be limited only by the scope of the appended claims.

1. An elastic averaging assembly, comprising:
a first component comprising:
a left longitudinal sidewall having a left inner sidewall surface;
a right longitudinal sidewall having a right inner sidewall surface; and
a first base wall integrally connecting to said left and right longitudinal sidewalls; and
a second component comprising:
a second base wall having a left longitudinal edge and a right longitudinal edge;
a plurality of left locating features integrally connected with said left longitudinal edge, each left locating feature of said plurality of left locating features having a left facing locating surface; and
a plurality of right locating features integrally connected with said right longitudinal edge, each right locating feature of said plurality of right locating features having a right facing locating surface;
wherein as said first and second components are mutually mated they mutually self-align by elastic averaging in which said left longitudinal sidewall flexes leftwardly as said left inner sidewall surface thereof slidingly abuts the left locating surface of each said left locating feature, and further in which said right longitudinal sidewall flexes rightwardly as said right inner sidewall surface thereof slidingly abuts the right locating surface of each said left locating feature.

2. The elastic averaging assembly of claim 1, further comprising:
a plurality of first ribs disposed on said first base wall disposed between said left and right longitudinal sidewalls; and
a plurality of second ribs disposed on said second base wall disposed between said left and right longitudinal edges;
wherein when said first component is mated to said second component, said first and second ribs are mutually conjoined to each other.

3. The elastic averaging assembly of claim 2, further comprising said first and second ribs being infrared welded to each other;
wherein the elastic averaging assembly has an inherent stiffness such that a localized torsional load from one of said first and second components to the other of said first and second components is transferred longitudinally with respect to said elastic averaging assembly.

4. The elastic averaging assembly of claim 1, wherein a precise alignment during mating of said first and second components by elastic averaging is generally defined locally at each of said left and right longitudinal edges, respectively, by: ΔX=ΔX′/√n+ΔX″/√n, where ΔX is a local structural variance of a length of local positional variation as between said first and second components when mated, ΔX′ is a local structural variance of a length of local position as between a respective one of said left inner sidewall surface and said left longitudinal edge and of said right inner sidewall surface and said right longitudinal edge, n is a number of a respective one of said plurality of left locating features and of said plurality of right locating features, and ΔX″ is a local structural variance of a length of thickness of a respective one of said left longitudinal sidewall and of said right longitudinal sidewall.

5. The elastic averaging assembly of claim 4, wherein:
said plurality of left locating features are disposed in substantially mutually equidistant relation along said left longitudinal edge; and
said plurality of right locating features are disposed in substantially mutually equidistant relation along said right longitudinal edge.

6. The elastic averaging assembly of claim 4, further comprising:
a plurality of first ribs disposed on said first base wall disposed between said left and right longitudinal sidewalls; and
a plurality of second ribs disposed on said second base wall disposed between said left and right longitudinal edges;
wherein when said first component is mated to said second component, said first and second ribs mutually conjoin each other.

7. The elastic averaging assembly of claim 6, further comprising said first and second ribs being infrared welded to each other;
wherein the infrared welded elastic averaging assembly has an inherent stiffness such that a localized torsional load from one of said first and second components to the other of said first and second components is transferred longitudinally with respect to said elastic averaging assembly.

8. An elastic averaging infrared welded assembly, comprising:
a first component comprising:
a left longitudinal sidewall having a left inner sidewall surface;
a right longitudinal sidewall having a right inner sidewall surface; and
a first base wall integrally connecting to said left and right longitudinal sidewalls;
a second component comprising:
a second base wall having a left longitudinal edge and a right longitudinal edge;
a plurality of left locating features integrally connected with said left longitudinal edge, said plurality of left locating features being disposed in substantially mutually equidistant relation along said left longitudinal edge, each left locating feature of said plurality of left locating features having a left facing locating surface; and
a plurality of right locating features integrally connected with said right longitudinal edge, said plurality of right locating features being disposed in substantially mutually equidistant relation along said right longitudinal edge, each right locating feature of said plurality of right locating features having a right facing locating surface;
a plurality of first ribs disposed on said first base wall disposed between said left and right longitudinal sidewalls; and
a plurality of second ribs disposed on said second base wall disposed between said left and right longitudinal edges, wherein said first and second ribs mutually a infrared welded to each other;
wherein said first and second components are mutually self-aligned with respect to each other by elastic averaging in which said left longitudinal sidewall is flexed leftwardly due to said left inner sidewall surface thereof abutting the left locating surface of each said left locating feature, and further in which said right longitudinal sidewall is flexed rightwardly due to said right inner sidewall surface thereof abutting the right locating surface of each said left locating feature; and
wherein the infrared welded elastic averaging assembly has an inherent stiffness such that a localized torsional load from one of said first and second components to the other of said first and second components is transferred longitudinally with respect to said elastic averaging assembly.

9. The elastic averaging infrared welded assembly of claim 8, wherein a precise alignment during mating of said first and second components by elastic averaging is generally defined locally at each of said left and right longitudinal edges, respectively, by: ΔX=ΔX′/√n+ΔX″/√n, where ΔX is a local structural variance of a length of local positional variation as between said first and second components when mated, ΔX′ is a local structural variance of a length of local position as between a respective one of said left inner sidewall surface and said left longitudinal edge and of said right inner sidewall surface and said right longitudinal edge, n is a number of a respective one of said plurality of left locating features and of said plurality of right locating features, and ΔX″ is a local structural variance of a length of thickness of a respective one of said left longitudinal sidewall and of said right longitudinal sidewall.

10. A method of self-aligning an assembly, comprising the steps of:
providing a first component comprising a left longitudinal sidewall and a right longitudinal sidewall, a first base wall integrally connecting to the left and right longitudinal sidewalls, and a plurality of first ribs formed on the first base wall;
providing a second base wall having a left longitudinal edge and a right longitudinal edge, a plurality of left locating features being integrally connected with the left longitudinal edge, a plurality of right locating features being integrally connected with the right longitudinal, and a plurality of second ribs formed on the second base wall; and
mutually mating the first component to the second component where during the first and second components mutually self-align with respect to each other by elastic averaging in which the left longitudinal sidewall is resiliently flexed leftwardly due to abutment with the plurality of left locating features and the right longitudinal sidewall is flexed rightwardly due to abutment with the plurality of right locating features.

11. The method of claim 10, further comprising infrared welding the first and second ribs together to thereby form an elastic averaging infrared welded assembly.

12. The method of claim 11, wherein a precise alignment during mating of said first and second components by elastic averaging is generally defined locally at each of said left and right longitudinal edges, respectively, by: ΔX=ΔX′/√n+ΔX″/√n, where ΔX is a local structural variance of a length of local positional variation as between said first and second components when mated, ΔX′ is a local structural variance of a length of local position as between a respective one of said left inner sidewall surface and said left longitudinal edge and of said right inner sidewall surface and said right longitudinal edge, n is a number of a respective one of said plurality of left locating features and of said plurality of right locating features, and ΔX″ is a local structural variance of a length of thickness of a respective one of said left longitudinal sidewall and of said right longitudinal sidewall.

13. The method of claim 12, wherein the elastic averaging infrared welded assembly has an inherent stiffness such that applying of a localized torsional load from one of said first and second components to the other of said first and second components is transferred longitudinally with respect to said elastic averaging assembly.
